(19) United States
(12) Patent Application Publication
(10) Pub. No.: US 2026/0163351 A1
(43) Pub. Date: Jun. 11, 2026

(54) INFORMATION PROCESSING APPARATUS

(71) Applicant: TOYOTA JIDOSHA KABUSHIKI KAISHA, Toyota-shi (JP)

(72) Inventor: Shota YAMADA, Okazaki-shi (JP)

(73) Assignee: TOYOTA JIDOSHA KABUSHIKI KAISHA, Toyota-shi (JP)

(21) Appl. No.: 19/408,802

(22) Filed: Dec. 4, 2025

(30) Foreign Application Priority Data
Dec. 5, 2024 (JP) 2024-211999

(51) Int. Cl. H02H 1/00; B60R 16/023; B60R 16/03

(52) U.S. Cl. CPC H02H 1/0092; B60R 16/0231; B60R 16/03; H02H 1/0061

(57) ABSTRACT

An information processing apparatus includes: a switching circuit section for emergency stop; a disconnecting circuit section; and a controller. The switching section is connected to the controller via a control line that monitors its energization, which changes in response to operation of an emergency stop switch. The disconnecting circuit section is connected to the controller via a drive line that monitors its energization, which changes in response to energization of a driving section that actuates a circuit breaker of the disconnecting circuit section. The switching and disconnecting circuit sections are linked by an interlock switch operating with the emergency stop switch to control power to the driving section. The controller acquires, via the control and drive lines, the respective energization states and determines whether an emergency stop is abnormal based on those states.

### CROSS REFERENCE TO THE RELATED APPLICATION

This application claims the benefit of Japanese Patent Application No. 2024-211999, filed on Dec. 5, 2024, which is hereby incorporated by reference herein in its entirety.

### BACKGROUND

### Technical Field

The present disclosure relates to an information processing apparatus.

### Description of the Related Art

Patent Literature 1 (Japanese Patent Laid-Open No. 2023-013128) discloses a transport vehicle. The transport vehicle disclosed in Patent Literature 1 includes a drive wheel, a motor for rotating the drive wheel, a motor drive circuit configured to control the supply of power to the motor, and a motor command unit configured to control the motor via the motor drive circuit.

In addition, the transport vehicle is equipped with a switching element installed on the power supply path to the motor drive circuit and a switching circuit that can toggle the conduction and non-conduction of the switching element, which are provided separately from the motor control unit, as well as an operation member installed on the transport vehicle that the user can operate.

The transport vehicle can operate in a manual mode where the motor runs when the control member is on and stops when the control member is off, and an automatic mode where the motor runs regardless of whether the control member is on or off.

### SUMMARY

An object of the present disclosure is to determine whether the emergency stop function of the device is operating normally.

One aspect of the present disclosure is an information processing apparatus comprising:
a switching circuit section for emergency stop of a device;
a disconnecting circuit section of the device; and
a controller, wherein
the switching circuit section:
   is connected to the controller via a control line for monitoring the energization status of the switching circuit section, and
   is configured so that the energization status through the control line changes in response to the operation of the emergency stop switch in the switching circuit section,
the disconnecting circuit section:
   is connected to the controller via a drive line for monitoring the energization status of the disconnecting circuit section, and
   is configured so that the energization status through the drive line changes in response to the energization to a driving section that drives a circuit breaker in the disconnecting circuit section,
the switching circuit section and the disconnecting circuit section are connected via an interlock switch that operates in conjunction with the emergency stop switch, and the interlock switch controls the power supply to the driving section,
the controller is configured to execute:
   obtaining, via the control line, whether the switching circuit section is energized,
   obtaining, via the drive line, whether the disconnecting circuit section is energized, and
   determining whether the emergency stop of the device is abnormal based on the whether the switching circuit section is energized, and whether the disconnecting circuit section is energized.

According to the present disclosure, it is possible to determine whether the emergency stop function of the device is operating normally.

### BRIEF DESCRIPTION OF THE DRAWINGS

FIG. 1 indicates a schematic configuration of the in-vehicle system;

FIG. 2 is a block diagram schematically indicates an example of the functional configuration of the in-vehicle device;

FIG. 3 indicates an example of an electrical circuit in an in-vehicle device;

FIG. 4 indicates the correspondence between the detection results of the command unit and the monitoring unit, and the state of the in-vehicle device; and

FIG. 5 is a flowchart of the determination process executed by the controller.

### DESCRIPTION OF THE EMBODIMENTS

Consider an information processing apparatus equipped with a switching circuit section for emergency stop of a device, a disconnecting circuit section of the device, and a controller. Here, it is assumed that the device is configured so that when the emergency stop switch in the switching circuit section is activated, the circuit breaker in the disconnecting circuit section operates to perform an emergency stop of the device. At this time, despite the emergency stop switch being activated, there are cases where the circuit breaker does not operate, making it impossible to perform a proper emergency stop of the device. Additionally, there are cases where the circuit breaker operates for reasons other than the activation of the emergency stop switch. In this way, when the activation of the emergency stop switch and the operation of the circuit breaker are not linked, the emergency stop of the device becomes abnormal.

In the information processing apparatus, the switching circuit section is connected to the controller via a control line for monitoring whether or not the switching circuit section is energized. Also, in the information processing apparatus, the disconnecting circuit section is connected to the controller via a drive line for monitoring whether or not the disconnecting circuit section is energized. As a result, the controller can grasp the energization status of the switching circuit section and the energization status of the disconnecting circuit section.

Here, the switching circuit section is configured so that the energization status via the control line changes in response to the operation of the emergency stop switch in the switching circuit section. In addition, the switching circuit section and the disconnecting circuit section are connected via an interlock switch that operates in conjunction with the emergency stop switch, and the interlock switch controls the power supply to the driving section. Then, when power is supplied to the driving section, the power energization status via the drive line of the disconnecting circuit section is configured to change. In other words, the energization status of the switching circuit section and the disconnecting circuit section changes when the emergency stop switch is activated.

Then, the controller acquires the presence or absence of energization in the switching circuit section via the control line. Also, the controller acquires the presence or absence of energization in the disconnecting circuit section via the drive line. Then, the controller determines whether the emergency stop of the device is abnormal or not based on the presence or absence of energization in the switching circuit section and the disconnecting circuit section.

As explained above, the abnormality of the emergency stop of the device is determined by the information processing apparatus according to whether the switching circuit section and the disconnecting circuit section are energized or not. This allows us to determine whether the emergency stop of the device is functioning properly.

Specific embodiments of the present disclosure will be described below on the basis of the drawings. The hardware configuration, module configuration, functional configuration, etc., described in each embodiment, unless otherwise stated, do not intend to limit the disclosed technical scope to those alone.

### Embodiment

### System Overview

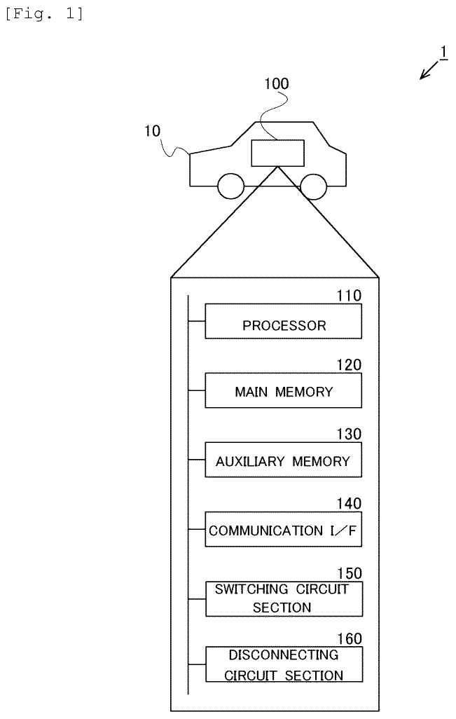

The in-vehicle system 1 according to the present embodiment will be described with reference to FIG. 1. FIG. 1 is a diagram showing a schematic configuration of the in-vehicle system 1. The in-vehicle system 1 includes an in-vehicle device 100. The in-vehicle device 100 is a device mounted on a vehicle 10. The in-vehicle device 100 is, for example, a device that outputs various information to the user of the in-vehicle device 100, such as a car navigation system.

Here, the in-vehicle device 100 is equipped with an emergency stop system. Here, the emergency stop system is configured to include a switching circuit section 150 and a disconnecting circuit section 160. The switching circuit section 150 is a circuit unit that includes a switch for performing an emergency stop of the in-vehicle device 100. The disconnecting circuit section 160 is a circuit unit that causes the in-vehicle device 100 to make an emergency stop by stopping the supply of electricity. Here, the disconnecting circuit section 160 is configured to bring the in-vehicle device 100 to an emergency stop in conjunction with the operation of the emergency stop switch in the switching circuit section 150. Also, the switching circuit section 150 operates either when the emergency stop button is pressed by the user of the in-vehicle device 100 or under the control of the controller in the system.

At this time, even though the emergency stop switch in the switching circuit section 150 has been activated, there are cases where the disconnecting circuit section 160 does not activate, making it impossible to properly perform an emergency stop of the in-vehicle device 100. Also, there are cases where the disconnecting circuit section 160 operates while the emergency stop switch in the switching circuit section 150 is not activated, causing the emergency stop of the in-vehicle device 100 to be carried out. In this way, when the emergency stop switch operation in the switching circuit section 150 and the disconnecting circuit section 160 are not linked, the emergency stop of the in-vehicle device 100 becomes abnormal.

The in-vehicle device 100 includes a computer configured with a processor 110, a main memory 120, an auxiliary memory 130, a communication interface (communication I/F) 140, a switching circuit section 150, and a disconnecting circuit section 160. The processor 110 is, for example, a CPU (Central Processing Unit) or a DSP (Digital Signal Processor). The main memory 120 is, for example, RAM (Random Access Memory). The auxiliary memory 130 is, for example, ROM (Read Only Memory). Also, the auxiliary memory 130 is, for example, a disk recording medium such as an HDD (Hard Disk Drive), CD-ROM, DVD disc, or Blu-ray disc. In addition, the auxiliary memory 130 may be a removable media (portable storage medium). Here, as removable media, for example, a USB memory or an SD card is illustrated. The communication I/F 140 is, for example, a LAN (Local Area Network) interface board or a wireless communication circuit for wireless communication.

In the in-vehicle device 100, the auxiliary memory 130 stores the operating system (OS), various programs, and various information tables, etc. Also, in the in-vehicle device 100, the processor 110 can realize various functions, as described later, by loading and executing the program stored in the auxiliary memory 130 into the main memory 120. However, some or all functions of the in-vehicle device 100 may be implemented by hardware circuits such as ASIC or FPGA. Note that the in-vehicle device 100 does not necessarily need to be realized by a single physical configuration, but may be configured by a plurality of computers that cooperate with each other.

### Functional Configuration

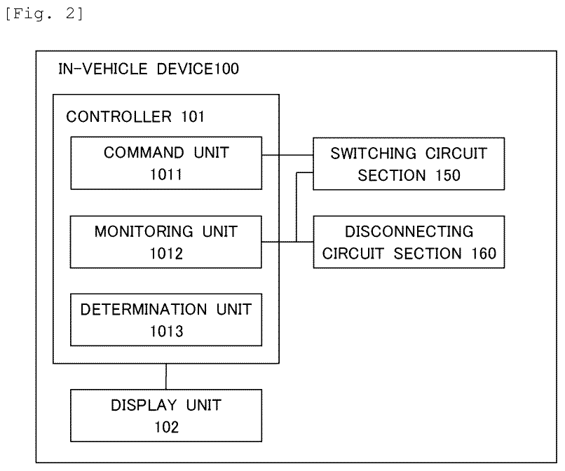

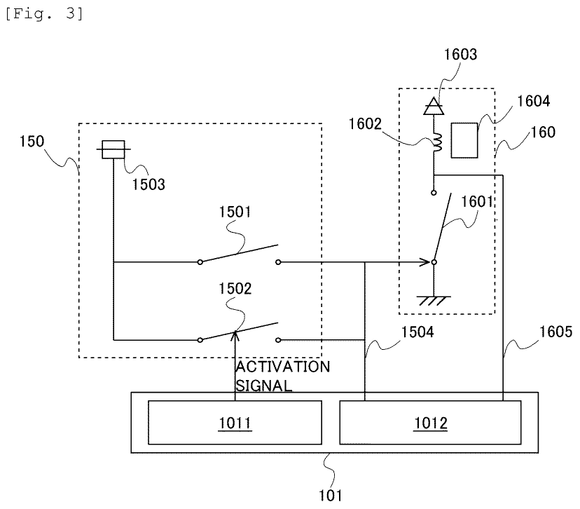

Next, the functional configuration of the in-vehicle device 100 will be explained based on FIG. 2 and FIG. 3. FIG. 2 is a block diagram that schematically indicates an example of the functional configuration of the in-vehicle device 100. The in-vehicle device 100 is configured to include a controller 101 and a display unit 102. The controller 101 has the function of performing computational processing to control the in-vehicle device 100. The controller 101 can be realized by the processor 110 in the in-vehicle device 100.

The controller 101, as a functional module, includes a command unit 1011, a monitoring unit 1012, and a determination unit 1013. The command unit 1011 issues commands (hereinafter sometimes referred to as “operation commands”) instructing the switching circuit section 150 to operate. The monitoring unit 1012 monitors the operating status of the switching circuit section 150 and the disconnecting circuit section 160. Additionally, the determination unit 1013 performs judgment processing to determine whether the emergency stop of the in-vehicle device 100 is abnormal, and to identify the cause of the emergency stop of the in-vehicle device 100, based on the operation status of the switching circuit section 150 and the disconnecting circuit section 160 monitored by the monitoring unit 1012. Details of how the command unit 1011 issues operation commands, how the monitoring unit 1012 monitors the operating status of the switching circuit section 150 and the disconnecting circuit section 160, and how the determination unit 1013 executes the judgment processing will be described later.

Display unit 102 has the function of displaying various information to the user of the in-vehicle device 100. Display unit 102 can be realized by a display in the in-vehicle device 100. Display unit 102 outputs the result of the judgment processing performed by determination unit 1013.

FIG. 3 indicates an example of an electric circuit in an in-vehicle device 100. As indicated in FIG. 3, in the in-vehicle device 100, the switching circuit section 150 is electrically connected to the monitoring unit 1012 via the command control line 1504. Additionally, the disconnecting circuit section 160 is electrically connected to the monitoring unit 1012 via the drive line 1605. The switching circuit section 150 is configured to include emergency stop switch (switch 1501 and switch 1502).

Here, the switch 1501 is a switch operated by a user of the in-vehicle device 100 pressing a button. The switch 1501 normally has its contacts separated and brings the contacts into contact in response to the user button press.

Additionally, the command unit 1011 issues an operation command to the switch 1502 according to the status of the in-vehicle device 100. Here, the command unit 1011 is electrically connected to the switch 1502. For example, when the command unit 1011 detects that an error has occurred in information processing in the in-vehicle device 100, it issues an operation command to the switch 1502. Also, when the command unit 1011 detects that a mechanical error has occurred in the in-vehicle device 100, it issues an operation command to the switch 1502. Specifically, the command unit 1011 issues an operation command by transmitting an activation signal to the switch 1502. Then, under normal conditions, the switch 1502, whose contacts are separated, brings the contacts together in response to the activation signal.

When switch 1501 or switch 1502 closes its contact, the circuit from the power supply node 1503, which supplies electricity, is connected to the monitoring unit 1012. Therefore, current flows into the monitoring unit 1012 from the power supply node 1503. As a result, the monitoring unit 1012 can detect the electricity supplied by the power supply node 1503. In other words, the monitoring unit 1012 can grasp that power is being supplied in the switching circuit section 150 according to the operation of switch 1501 or switch 1502.

The disconnecting circuit section 160 includes a switch 1601, a coil 1602, a relay circuit 1603, and a circuit breaker 1604. Here, relay circuit 1603 is a relay circuit for operating circuit breaker 1604. Also, coil 1602 is a coil for driving circuit breaker 1604. The circuit breaker 1604 operates by the magnetic force generated when the coil 1602 is energized, and it is a circuit that interrupts the power supply to the in-vehicle device 100. In this embodiment, the embodiment breaker 1604 is driven by the coil 1602. However, circuit breaker 1604 may be driven by something other than coil 1602. Circuit breaker 1604 may, for example, be driven by a mechanically connected device.

Here, the relay circuit 1603 is electrically connected to the coil 1602. Additionally, the coil 1602 is electrically connected to the monitoring unit 1012. In other words, the relay circuit 1603, the coil 1602, and the monitoring unit 1012 are electrically connected in the order of the relay circuit 1603, the coil 1602, and then the monitoring unit 1012. At this time, a faint current flowing from the relay circuit 1603 enters the monitoring unit 1012.

Also, switch 1601 is a switch that operates in conjunction with switch 1501 and switch 1502. When at least one of switch 1501 or switch 1502 makes contact, switch 1601 also makes contact accordingly. Switch 1601 is configured to be electrically or mechanically linked with switch 1501 and switch 1502.

Here, the coil 1602 is electrically connected to the switch 1601. Also, the switch 1601 is grounded. Here, the switch 1601 branches from the electrical connection of coil 1602 and the monitoring unit 1012 to connect to the coil 1602. In other words, the switch 1601 is connected in parallel with the drive line 1605.

On the other hand, when at least one of switch 1501 or switch 1502 is activated, switch 1601 also operates, causing the relay circuit 1603 and coil 1602 to be connected to ground. As a result, current from the relay circuit 1603 flows into the coil 1602 and then is released to ground after passing through switch 1601. At this time, the current flowing from the relay circuit 1603 is greater than a weak current and is sufficient to activate circuit breaker 1604 via coil 1602. Accordingly, the circuit breaker 1604 operates in response to the electromagnetic force generated by the current flowing from the relay circuit 1603 into the coil 1602, causing the emergency stop of the in-vehicle device 100.

At this time, the current from the relay circuit 1603 no longer flows into the monitoring unit 1012. Therefore, when the switch 1601 operates, the monitoring unit 1012 stops detecting the weak current flowing from the relay circuit 1603. Thus, when the current flowing from the relay circuit 1603 is no longer detected, the monitoring unit 1012 can recognize that the switch 1601 has operated.

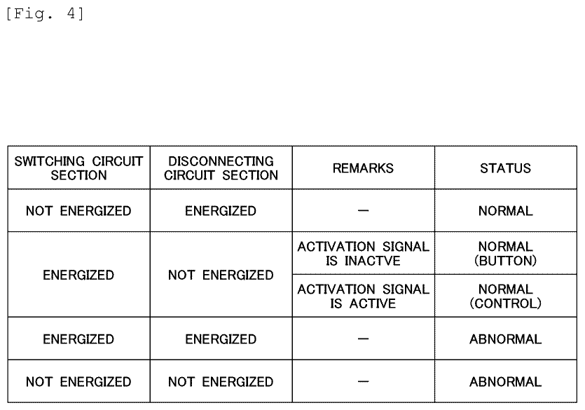

FIG. 4 indicates the correspondence between the detection results of the command unit 1011 and the monitoring unit 1012 and the state of the in-vehicle device 100. When switches 1501 and 1502 are not operating, no current flows into monitoring unit 1012 from power node 1503. On the other hand, when switches 1501 and 1502 are not operating, normally weak current flows into monitoring unit 1012 from relay circuit 1603 because switch 1601 is also not operating. Therefore, when the monitoring unit 1012 does not detect the energization of the switching circuit section 150 but does detect the energization of the disconnecting circuit section 160, the in-vehicle device 100 operates normally.

Also, when at least one of switch 1501 or switch 1502 is activated, current flows into the monitoring unit 1012 from the power supply node 1503. On the other hand, since switch 1601 is activated in conjunction with the operation of at least one of switches 1501 and 1502, as described above, current no longer flows into the monitoring unit 1012 from the power supply node 1503. Therefore, if the monitoring unit 1012 detects the power supply to the switching circuit section 150 and does not detect the power supply to the disconnecting circuit section 160, the in-vehicle device 100 is in a normal emergency stop state.

Here, the controller 101 can determine whether the switch 1502 has been activated by judging whether the command unit 1011 has sent an activation signal to the switch 1502. Therefore, the controller 101 can ascertain which switch, either switch 1501 or switch 1502, has been activated depending on the presence or absence of the transmission of the activation signal. In other words, the controller 101 can understand whether the emergency stop is due to the emergency stop button or the emergency stop is controlled by the controller 101 (command unit 1011).

Also, there may be cases where the interlocking of switch 1601 in response to the operation of at least one of switch 1501 and switch 1502 does not function properly. Here, if the interlocking of switch 1601 does not function properly, it is, for example, due to a failure of switch 1601 or a failure of the device responsible for interlocking with switches 1501 and 1502. Therefore, when the monitoring unit 1012 detects the energization of the switching circuit section 150 and also detects the energization of the disconnecting circuit section 160, it can recognize that the in-vehicle device 100 is in an abnormal state without undergoing an emergency stop.

Also, even when neither switch 1501 nor switch 1502 is operating, the disconnecting circuit section 160 may activate due to a malfunction or other reason in the in-vehicle device 100. In this case, the monitoring unit 1012 does not detect the energization of the switching circuit section 150, nor does it detect the energization of the disconnecting circuit section 160. Therefore, in this case, it is possible to determine that the emergency stop of the in-vehicle device 100 was not by the emergency stop button or by the control of the controller 101 (command unit 1011), but an abnormal emergency stop.

Therefore, the determination unit 1013 in the controller 101 executes a process (determining process) to determine whether the emergency stop of the in-vehicle device 100 is abnormal or not, based on whether the switching circuit section 150 is energized and whether the disconnecting circuit section 160 is energized. When the determination unit 1013 determines that the emergency stop of the in-vehicle device 100 is abnormal, it outputs abnormality notification information to the display unit 102. Here, the abnormality notification information is information indicating that the emergency stop of the in-vehicle device 100 is abnormal.

Moreover, when the emergency stop is not abnormal (i.e., it is normal), the determination unit 1013 outputs normal stop information to the display unit 102. At this time, the normal stop information includes information indicating whether the emergency stop was due to the emergency stop button or the control by the controller 101 (command unit 1011).

### Flowchart

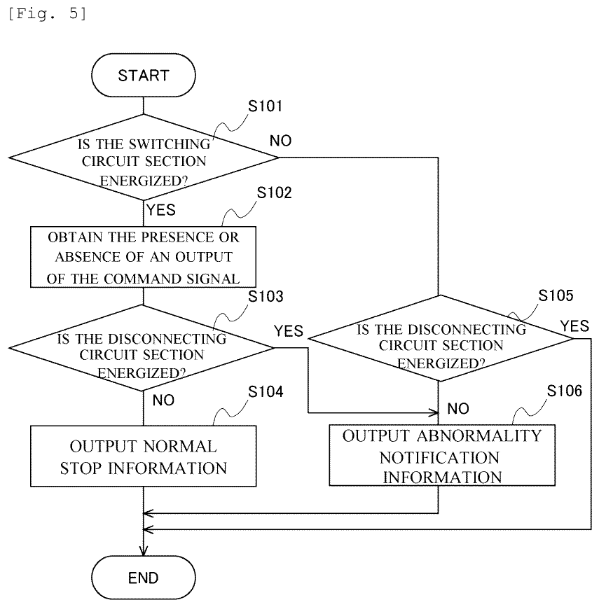

Next, the determination process executed by the controller 101 (determination unit 1013) in the in-vehicle device 100 of the in-vehicle system 1 will be explained based on FIG. 5. FIG. 5 is a flowchart of the determination process executed by the controller 101. The determination process is repeatedly started at predetermined intervals.

In the judgment process, it is first determined at S101 whether the switching circuit section 150 is energized through the control line 1504. Specifically, the presence or absence of power supply to the switching circuit section 150 is obtained from the monitoring unit 1012, and it is determined whether the switching circuit section 150 is energized.

If an affirmative judgment is made in S101, then in S102, the presence or absence of an output of the command signal from the command unit 1011 to the switch 1502 is obtained. Next, in S103, it is determined whether the disconnecting circuit section 160 is energized through the drive line 1605. Specifically, the monitoring unit 1012 obtains whether the disconnecting circuit section 160 is energized and determines whether the disconnecting circuit section 160 has been activated.

If a negative determination is made in S103, the monitoring unit 1012 detects the energization of the switching circuit section 150 and does not detect the energization of the disconnecting circuit section 160. Therefore, the in-vehicle device 100 is emergency stopped normally. Then, in S104, normal stop information is output to the display unit 102. As a result, the user of the in-vehicle device 100 can understand that the emergency stop has been carried out normally. And then, the judgment process is temporarily concluded.

Also, when an affirmative determination is made at S103, the monitoring unit 1012 detects that the switching circuit section 150 is energized and also that the disconnecting circuit section 160 is energized. Therefore, it is possible to grasp that although the emergency stop switch is activated, the emergency stop of the in-vehicle device 100 was not performed properly. Then, at S106, abnormality notification information is output. At this time, the abnormality notification information includes information indicating that the emergency stop has not been performed properly. As a result, the user of the in-vehicle device 100 can recognize that the emergency stop has not been carried out correctly. And then, the judgment process is temporarily concluded.

Also, if a negative judgment is made in S101, it is determined in S105 whether or not the disconnecting circuit section 160 is energized. If an affirmative judgment is made in S105, the monitoring unit 1012 does not detect the energization of the switching circuit section 150 and detects the energization of the disconnecting circuit section 160. Therefore, since the in-vehicle device 100 is operating normally, the judgment process is temporarily terminated.

If a negative determination is made in S105, the monitoring unit 1012 does not detect power supply to the switching circuit section 150 and does not detect power supply to the disconnecting circuit section 160. Therefore, an abnormal emergency stop has been performed on the in-vehicle device 100. Accordingly, in S106, abnormal notification information is output to the display unit 102. Here, the abnormal notification information includes information indicating that an abnormal emergency stop has occurred in the in-vehicle device 100. This enables the user of the in-vehicle device 100 to understand that an abnormal emergency stop of the in-vehicle device 100 has occurred. And then, the judgment process is temporarily concluded.

As explained above, in the onboard system 1, whether the emergency stop of the in-vehicle device 100 is abnormal or not is determined according to the presence or absence of power supply to the switching circuit section 150 and the in-vehicle device supply to the disconnecting circuit section 160. In other words, it is determined whether the emergency stop of the in-vehicle device 100 was carried out normally or if the emergency stop is abnormal. Also, when the in-vehicle device 100 performs an emergency stop normally, the cause of the emergency stop of the in-vehicle device 100 is identified based on the presence or absence of power supply to the switching circuit section 150 and the power supply to the disconnecting circuit section 160. In this way, it is possible to grasp whether the emergency stop function of the in-vehicle device 100 is functioning properly or not.

### Modification 1

In this embodiment, the emergency stop system is mounted on the in-vehicle device 100. However, the emergency stop system may also be mounted on any device other than the in-vehicle device 100. For example, the emergency stop system may be mounted on a stationary device or a portable device.

### Modification 2

In this embodiment, when switch 1501 or switch 1502 is activated, electricity is supplied via the control line 1504. Also, in this embodiment, switch 1601 is connected in parallel with the drive line 1605, and when switch 1601 is activated, it is configured to block the flow of electricity through the drive line 1605. However, if the energization status via the control line changes according to the operation of switch 1501 or switch 1502, and the energization status via the drive line 1605 changes when switch 1601 operates, a configuration different from the present embodiment may be adopted. In this case, the controller 101 determine whether the emergency stop of the in-vehicle device 100 is abnormal based on the presence or absence of conduction via the control line 1504 and the presence or absence of conduction via the drive line 1605.

### Other Embodiment

The above embodiment is merely an example, and present disclosure can be implemented with appropriate modifications as long as they do not deviate from the essence thereof. Also, the processes and means described in present disclosure can be freely combined and implemented as long as no technical contradictions arise.

Also, the processes described as being performed by a single device may be divided and executed by multiple devices. Alternatively, the processes described as being performed by different devices may be executed by a single device. In computer systems, the implementation of each function with specific hardware configurations (server setups) can be flexibly changed.

The present disclosure can also be realized by supplying a computer program that implements the functions described in the above embodiment to a computer, and the one or more processor of the computer reading and executing the program. Such a computer program may be provided to the computer via a non-transitory computer-readable storage medium connected to the computer's system bus or provided to the computer via a network. Non-transitory computer-readable storage media include, for example, any type of disk such as magnetic disks (floppy disks or hard disk drives (HDDs)), optical disks (CD-ROMs, DVD discs, or Blu-ray discs, etc.), read-only memory (ROM), random access memory (RAM), EPROM, EEPROM, magnetic cards, flash memory, or optical cards,—any type of medium suitable for storing electronic instructions.

What is claimed is:

1. An information processing apparatus comprising:
a switching circuit section for emergency stop of a device;
a disconnecting circuit section of the device; and
a controller, wherein
the switching circuit section:
is connected to the controller via a control line for monitoring the energization status of the switching circuit section, and
is configured so that the energization status through the control line changes in response to the operation of the emergency stop switch in the switching circuit section,
the disconnecting circuit section:
is connected to the controller via a drive line for monitoring the energization status of the disconnecting circuit section, and
is configured so that the energization status through the drive line changes in response to the energization to a driving section that drives a circuit breaker in the disconnecting circuit section,
the switching circuit section and the disconnecting circuit section are connected via an interlock switch that operates in conjunction with the emergency stop switch, and the interlock switch controls the power supply to the driving section,
the controller is configured to execute:
obtaining, via the control line, whether the switching circuit section is energized,
obtaining, via the drive line, whether the disconnecting circuit section is energized, and
determining whether the emergency stop of the device is abnormal based on the whether the switching circuit section is energized, and whether the disconnecting circuit section is energized.

2. The information processing apparatus according to claim 1, wherein
being configured so that the energization status through the control line changes includes allowing energization via the control line, and
being configured so that the energization status through the drive line changes includes the interlock switch and the drive line are connected in parallel, and when the interlock switch operates, it connects the driving section to ground and interrupts energization via the drive line.

3. The information processing apparatus according to claim 2, wherein
determining whether the emergency stop of the device is abnormal includes determining the emergency stop is abnormal when the switching circuit section is energized through the control line and the disconnecting circuit section is energized through the drive line.

4. The information processing apparatus according to claim 2, wherein
determining whether the emergency stop of the device is abnormal includes determining the emergency stop is abnormal when the switching circuit section is not energized through the control line and the disconnecting circuit section is not energized through the drive line.

5. The information processing apparatus according to claim 2, wherein
the emergency stop switch includes A first switch operated by user action and a second switch operated under control of the controller, and
the controller is configured to further execute:
determining the emergency stop is normal when the switching circuit section is energized through the control line and the disconnecting circuit section is not energized through the drive line, and
identifying which one of the first switch and the second switch has operated.
